(19) United States
(12) Patent Application Publication
(10) Pub. No.: US 2006/0217279 A1
(43) Pub. Date: Sep. 28, 2006

(54) Surface treatment compositions for foaming process

(76) Inventor: Larry Rising, Kernersville, NC (US)

Correspondence Address: LARRY RISING, 3820 Firestone Rd, Kernersville, NC, 27284, US

(21) Appl. No.: 11/443,687

(22) Filed: Jun. 1, 2006

Related U.S. Application Data
(63) Continuation-in-part of application No. 10/611,746, filed on Jun. 30, 2003, now abandoned.

(51) Int. Cl. C11D 7/32

(52) U.S. Cl. 510/175; 524/544; 510/285; 510/412

(57) ABSTRACT

The object of the invention is to provide a non-aqueous fluorine containing surface treatment composition and treated textile. The surface treatment composition can be made into foam for low energy application and to control depth or penetration of surface treatment. Surface treatment can be applied by current commercially available foam application equipment, with excellent storage stability and performance characteristics as a surface treatment agent and is highly safe due to the non-flammability or flame retardancy. The composition should be environmentally friendly, a low energy process with limited negative impact to ozone layer depletion and global warming.

### BACKGROUND OF THE INVENTION

Fluoro-chemicals are now applied to substrates via foam application with water based (aqueous) carriers requiring other auxiliary chemicals i.e.: emulsifiers, foaming agents, wetting agents and dispersing agents to keep organics in suspension.

These auxiliary chemicals needed for aqueous application often lesson the intended benefit of the applied chemical to the substrate. Aqueous chemistries require high curing temperatures and expensive drying systems to evaporate the water. Chlorinated hydrocarbons have been used in the past as carrier mediums to apply organic chemicals to substrates when an aqueous carrier could not be used. Chlorinated hydrocarbons are being phased out by mandate of the Environmental Protection Agency (EPA).

Chlorofluorocarbons have been widely used as solvents for solvent-based fluorine-containing surface treatment compositions because the chlorofluorocarbons are less toxic, nonflammable and chemically stable. Particularly CFC-113, which has a moderate boiling point, has been widely used. However, ozone layer depletion by specific chlorofluorocarbons such as CFC-113 became a problem and production of such chlorofluorocarbons has been discontinued on a worldwide scale.

### BRIEF SUMMERY OF THE INVENTION

By this invention, NPB (n-propyl bromide) and similar solvents have shown to be an excellent alternative to current aqueous and chlorinated hydrocarbons as a carrier medium for foam application of organics to substrates. NPB is an example of a non-regulated, non-toxic and has very little ozone pollution properties. NPB is economical and environmentally friendly. U.S. Pat. No. 4,655,056 teaches how to apply aqueous foam for surface treatment and is incorporated herein in its entirety by reference.

After extensive study, it has been found that the use of NPB as a non-aqueous carrier for foam application dramatically improves the performances and durability of textiles and that this invention is superior to current methods and chemistry being applied by foam.

### DETAILED DESCRIPTION OF THE PREFERRED EMBODIMENTS

The invention relates to non-aqueous foaming formulations to provide substrates with treatment to include oil and water repellent treatment, for example; the treatment of home textiles and apparel, which achieve desired effects with significantly smaller amounts of expensive fluorocarbon compounds as compared to available current technology, as illustrated in Example 1 compared to Example 4.

In addition, this invention relates to the finishing of washable fabric intended to be made into wearing apparel and home textiles and more specifically to the finishing of such fabric with an insecticide, such as permethrin, by a process that increases the knock-down efficacy and the retention of the insecticide in the fabric through successive washings.

U.S. Pat. No. 5,198,287, incorporated herein in its entirety by reference, teaches that the application of permethrin with fluorochemicals can be done successfully. By this invention it was discovered that the incorporation of a cross linker with the fluorochemical and permethrin greatly increased the effective life of the insecticide benefit on the fabric. By foaming application, the surface treatment is mechanically placed on the outside of the fabric so to not contact the skin side of a garment, or creating a two sided fabric or substrate or placed on the inside of a tent fabric to shield the permethrin from ultra violet rays and oxygen which degrade its' effectiveness. By foaming application, the penetration depth of the surface treatment can be controlled very accurately, allowing one surface treatment to be applied to one side of the substrate and a different surface treatment being applied to the opposite side of the substrate. An example would be applying insect repellent to the inside of a tent and a ultra violet inhibitor to the outside of the tent.

The following description, taken in conjunction with the referenced examples, is presented to enable one of ordinary skill in the art to make and use the invention. Various modifications will be readily apparent to those Skilled in the art, and the general principles defined herein may be applied to a wide range of aspects. Thus, the present invention is not intended to be limited to the aspects presented, but is to be accorded the widest scope consistent with the principles and novel features disclosed herein. Furthermore, the compositions according to the invention should furthermore impart to the substrates, in particular the home textiles, water-repellent actions that meet increased requirements.

Another object comprises providing treatment compositions with which the heat treatment can be carried out at the lowest temperature or, preferably, no heat treatment being necessary (Example 3).

In one aspect, invention relates to substrates from the group consisting of naturally occurring and synthetic textiles and their mixtures, leather, mineral substances, thermoplastic and thermosetting polymers and paper, which are treated with fluorine-containing compositions of the type mentioned below in an amount of 10 to 10,000 ppm, preferably 50 to 5,000 ppm, particularly preferably 100 to 2,000 ppm, calculated as fluorine and based on the total weight of substrates provided with an oil-, water- and soil-repellent treatment. In another aspect, other textile auxiliary chemicals can be added during preparation of the treatment formula as according to the invention, or subsequently. Such additives are crease-proofing and soft handle agents, melamine, flame retardant, oleophobizing agents, hydrophobizing agents, urethane, finishing agents, extenders, insect repellents and antimicrobials for textile auxiliaries and others.

The invention also relates to surface treated fabrics that are treated to be water resistant and insect repellent. According to the invention, the duration of insect repellence is increased by the use of one or more barriers to protect the treated fabric from exposure to water and/or ultra violet rays.

Substrates which are suitable for imparting oil-, water-, soil-repellant and insect repellence properties according to the invention are: linen, cotton, wool, silk, jute, polyamide, polyester, polyacrylonitrile and mixtures thereof, leather, stone slabs, floor tiles, glazed tiles, roof tiles, glass, ground surfaces of silicon, foils and films and compact workpieces of polyolefins, polyesters, polyamides, polycarbonates, polyurethane, polyacetals, polyethers, polysulphides, polysulphones, polyamides and other thermoplastics, as well as of phenol/formaldehyde resins, urea/formaldehyde resins, melamine/formaldehyde resins and other thermosetting resins, paper and paper-like materials, such as paperboard. Preferred base substrates are home textiles based on naturally occurring and synthetic textiles and their mixtures, which are employed, for example, as carpets, curtains, decorative materials or coverings for upholstered furniture.

Processes for the treatment of such base substrates and therefore for application of the fluorine-containing compositions according to the invention are known to the expert and are, for example, foaming, dipping or spraying of the base substrates; the compositions according to the invention furthermore can be employed during the production of the base substrates, for example the pulp.

Textiles as base substrates, preferably home textiles and apparel can be treated, for example, in the padding, spraying or foaming process.

The padder consists of a liquor trough (chassis) and at least one pair of rubber rolls (Example 2). The textiles to be treated are impregnated with the treatment liquor in the chassis and squeezed off between the rolls; the liquor runs back into the chassis. It is very important that a uniform liquor pick-up is achieved over the entire width of the goods during squeezing-off. In the padding process, the liquor pick-up is stated in percentage of the weight of goods, and for normal textile constructions can be between 30 and 300%, depending on the quality of the goods and the padder pressure used.

In the spraying process, (Example 3) the textile is sprayed with the treatment liquor. The treatment liquor is finely divided by nozzles and applied uniformly. An amount of treatment liquor precisely defined beforehand is applied to one square meter of textile goods.

In the foaming process, the treatment liquor is continuously foamed mechanically in a commercially available mixer with out the addition of a foaming agent. The foam is produced in the mixing head by mixing the liquor with air. The foam, which emerges, is conveyed via a foam line to a discharge slot in the applicator. The goods are pressed against the slot and taken off via a separate unit, for example a stenter frame. In example 1, a concentration of 98% NPB and 2% Perfluoroalkyl polyacrylate were used. The experiments were carried out on the Gaston Systems, Inc. Foam Applicator, Stanley, N.C.

By the invention, it has been discovered surprisingly that mixtures of NPB and Perfluoroalkyl polyacrylate can be foamed with or without the aid of a foaming agent (Example 1). Not using foaming agents greatly improves the benefit of the applied fluorine composition to the substrate and reduces the amount of compound added to fabric to achieve water and oil repellency.

In another aspect, this invention involves the surprising discovery that the use of NPB applied in 100% concentration via dipping and squeezing with pressure rollers (Padding) and the NPB being evaporated away imparts a much improved softness and luster to textile substrates, especially home furnishing, apparel fabrics and upholstery fabrics.

After the treatment, the textiles, preferably home textiles, are dried, it being possible to use temperatures of 120.degree. to 170.degree. C. to achieve the desired treatment effect according to the known procedure. However, good oil-, water- and soil-repellant treatments can also be obtained with the new compositions according to the invention at significantly lower drying temperatures, for example at 25.degree. C. (Example 3).

Samples of the materials thus pretreated were taken for testing of the following effects:

Oil-repellency (according to AATCC 118-1972): The test sample is placed on a horizontal, smooth surface, a small drop (drop diameter about 5 mm) of he test liquids is applied to the test sample with the aid of a dropping pipette, In addition, the sample is evaluated as specified.

The AATCC oil-repellency level of a test fabric is the highest number of that test liquid which does not wet or penetrate into the test material within a time span of 30 seconds. The test liquids and mixtures for the test method are: No. 1: Nujol or paraffin oil DAB 8; No. 2: 65% by volume of Nujol and 35% by volume of n-hexadecane; No. 3: n-hexadecane; No. 4: n-tetradecane; No. 5: n-dodecane; No. 6: n-decane; No. 7: n-octane; No. 8: n-heptane.

Repellency towards a water/alcohol mixture (hydrophobicity): Drops of water/isopropanol mixtures (ratio 90/10 to 10/90) are applied to the test sample. The test result corresponds to the mixture with the highest isopropanol content which remains on the test sample in unchanged form for at least 20 seconds (the value 80/20, for example, is better than 20/80).

### EXAMPLES

Compositions which are not according to the invention (Example 4) and which represent the prior art are the following: Nuva HPU (Clariant Corporation). Scotchgard.RTM. FC 396 (3M Comp.) according to DE-A 2 149 292 Baygard.RTM. SF-A. (Bayer AG) according to DE-A 3 307 420 and Zonyl (E.I. Dupont)

The compositions according to the invention (Examples 1, 2 & 3) are non-aqueous solutions contents of which comprise a mixture of NPB (component A) and one or more poly(meth)acrylates (component B).

### Use of the Compositions According to the Invention

### Example 1

A solution of 98% NPB and 2% Perfluoroalkyl polyacrylate were mixed and applied to the foam generator which imparts the solution to a high speed mixer that generates the solution into foam. The foam was then dispensed to the substrates listed in below via an applicator at 30%-wet pickup. The substrates were then dried at 170 deg C. for 1-minute dwell time with the following results:

| Initial | | | | | After 10 Home Laundries | | | |
|---|---|---|---|---|---|---|---|---|
| Example 1 | Oil | IPA | Spray | Fluoride | Oil | IPA | Spray | Fluoride |
| Cotton | 5 | 85 | 100 | 2160 ppm | 2 | 60 | 70 | 1600 ppm |
| Polyester | 6 | 90 | 100 | 1170 ppm | 5 | 90 | 90 | 980 ppm |
| Pes/Rayon | 6 | 80 | 100 | | 5 | 60 | 70 | |

### Example 2

A solution of 99.6% NPB and 0.4% Perfluoroalkyl polyacrylate were mixed and applied to the substrates listed below via a pad applicator at 3.5 bars pressure. The solution was applied at noted wet pickup. Again, the substrates were dried at 170 deg C. with a 1-minute dwell.

| Initial | | | | | After 10 Home Laundries | | | |
|---|---|---|---|---|---|---|---|---|
| Example 2 | Oil | IPA | Spray | Fluoride | Oil | IPA | Spray | Fluoride |
| Cotton | 6 | 100 | 100 | 2480 ppm | 3 | 90 | 80 | 2200 ppm |
| Polyester | 8 | 90 | 100 | 1270 ppm | 6 | 90 | 90 | 1100 ppm |
| Pes/Rayon | 8 | 80 | 100 | | 6 | 80 | 80 | |

### Example 3

A solution of 99.6% NPB and 0.4% Perfluoroalkyl polyacrylate were mixed and applied to the substrates listed below via a Spray at 1.5 bars pressure. The solution was applied at noted wet pickup. Again, the substrates were dried at 170 deg C. with a 1-minute dwell.

| Initial | | | | | After 10 Home Laundries | | | |
|---|---|---|---|---|---|---|---|---|
| Example 3 | Oil | IPA | Spray | Fluoride | Oil | IPA | Spray | Fluoride |
| Cotton | 6 | 85 | 100 | 2260 ppm | 2 | 60 | 70 | 1690 ppm |
| Polyester | 6 | 90 | 100 | 1170 ppm | 5 | 90 | 90 | 1080 ppm |
| Pes/Rayon | 6 | 80 | 100 | | 5 | 60 | 70 | |

### Use of the Compositions Not According to the Invention

### Example 4

An aqueous Perfluoroalkyl polyacrylate dispersion using Nuva HPU at 2% concentration was prepared and applied via a padding applicator at 3.5 bars pressure. The solution was applied at noted wet pickup. Again, the substrates were dried at 170 deg C. with a 1-minute dwell.

| Initial | | | | | After 10 Home Laundries | | | |
|---|---|---|---|---|---|---|---|---|
| Example 4 | Oil | IPA | Spray | Fluoride | Oil | IPA | Spray | Fluoride |
| Cotton | 7 | 100 | 100 | 2460 ppm | 7 | 90 | 80 | 2210 ppm |
| Polyester | 6 | 60 | 100 | 1270 ppm | 4-5 | 45-50 | 90 | 1100 ppm |
| Pes/Rayon | 5 | 60 | 100 | | 2 | 35-40 | 70 | |

In all examples, the substrates used were (1) White Polyester 8 oz/sq yd (PES), (2) 100% Cotton interlock and (3) 60/40 PES and Rayon Blend.

What is claimed is:

1. A water and oil repellent composition for foaming process of a treated textile comprising:
(A) a fluorine-containing polymer or copolymer,
(B) a solvent component containing 5 wt. % or more of a chlorine-free, non-flammable halogen-containing solvent which has an ozone depletion potential (ODP) of 0.03 or less, a 100-year integrated global warming potential (GWP) value of 500 or less, and a kauri butanol (KB) value of 5 or more and a surface tension of 40 dynes/cm or less.

2. A water and oil repellent composition according to claim 1, wherein the fluorine containing component (A) is a surface treatment component comprises at least one species selected from the group consisting of: (1) phosphorus-containing compounds having at least one fluorine-containing group selected from the group consisting of polyfluoroalkyl groups and polyfluoroalkenyl groups; (2) highly fluorinated organic compounds; and (3) polymers prepared using, as a monomer component, a compound having at least one fluorine-containing group selected from the group consisting of polyfluoroalkyl groups and polyfluoroalkenyl groups, said highly fluorinated organic compound (2) being at least one compound selected from the group consisting of: (A) at least one fluoroalkane selected from the group consisting of (CF.sub.3).sub.2 CF(CF.sub.2).sub.4 CF(CF.sub.3).sub.2 and ##STR36## (B) at least one fluorochloro polyether selected from the group consisting of: F(CHClCF.sub.2 CF.sub.2 O).sub.n CHClCF.sub.3 (n is 5 on an average); F(CCl.sub.2 CF.sub.2 CF.sub.2 O).sub.n CCl.sub.2 CF.sub.3 (n is 5 on an average); F(CCl.sub.2 CF.sub.2 CF.sub.2 O).sub.n CCl.sub.2 CF.sub.2 Cl (n is 25 on an average); CCl.sub.2 FCF.sub.2 CF.sub.2 OCCl.sub.2 CF.sub.2 CF.sub.2 OCCl.sub.2 CF.sub.3; F(CCl.sub.x F.sub.y CF.sub.2 CF.sub.2 O).sub.n CCl.sub.x F.sub.y CF.sub.3 (n is 5 on an average), x+y=2, x:y=1:4); F(CF.sub.2 CF.sub.2 CF.sub.2 O).sub.x (CClFCF.sub.2 CF.sub.2 O).sub.y —CF.sub.2 CF.sub.2 COF (x+y is 20 on an average, x:y=2:1, x number of units and y number of units are arranged in a random order); and F(CF.sub.2 CF.sub.2 CF.sub.2 O).sub.x (CClFCF.sub.2 CF.sub.2 O).sub.y CF.sub.2 CF.sub.3 (x+y is 20 on an average, x:y=2:1, x number of units and y number of units are arranged in a random order), and (C) fluorochloroolefin telomers whose main portion, defined as a portion except for terminal groups, is composed of repeating units of —CF.sub.2 CFCl—, the total of the repeating units of chlorotrifluoroethane in terms of degree of telomerization being 3 to 20, and said polymer (3) prepared using as, a monomer component, a compound having at least one fluorine-containing group selected from the group consisting of polyfluoroalkyl groups and polyfluoroalkenyl groups being at least one polymer selected from the group consisting of:
(A) a copolymer of at least one fluorine-containing monomer selected from the group consisting of polyfluoroalkyl-containing (meth)acrylic esters, polyfluoroalkenyl-containing (meth)acrylic esters, polyfluoroalkyl-containing vinyl compounds and poly-fluoroalkenyl-containing vinyl compounds, and another monomer copolymerizable therewith, the proportion of the fluorine-containing monomer being 20-95 parts by weight, based on 100 parts by weight of the total monomer component, and
(B) a polymer of at least one fluorine-containing monomer selected from the group consisting of polyfluoroalkyl-containing epoxy monomers and polyfluoroalkenyl-containing epoxy monomers, or a copolymer of the fluorine-containing monomer and another monomer copolymerizable therewith, the proportion of the fluorine-containing monomer being 20-100 parts by weight, based on 100 parts by weight of the total monomer component.

3. A Water and oil repellent composition according to claim 1, wherein the fluorine containing component (A) is a surface treatment component comprises a polymer prepared using as a monomer component having at least one fluorine-containing group selected from the group consisting of polyfluoroalkyl groups and polyfluoroalkenyl groups.

4. A Water and oil repellent composition according to claim 1, wherein the solvent component (B) is stabilized. wherein said stabilizer (or corrosion inhibitor) is selected from the group consisting of alkanols having 4 to 7 carbon atoms, nitroalkanes having 1 to 3 carbon atoms, 1,2-epoxyalkanes having 2 to 7 carbon atoms, acetylene alcohols having 3 to 9 carbon atoms, phosphite esters having 12 to 30 carbon atoms, ethers having 3 to 6 carbon atoms, unsaturated hydrocarbon compounds having 4 to 7 carbon atoms, triazoles, acetals having 4 to 7 carbon atoms, ketones having 3 to 5 carbon atoms, amines having 6 to 8 carbon atoms, and mixtures thereof.

5. A Water and oil repellent composition according to claim 1, wherein the solvent component (B) is NPB (n-propyl bromide) stabilized.

6. A Water and oil repellent composition according to claim 1, wherein the solvent component (B) is a bromine-containing solvent and is a C.sub.1-3 halogenated hydrocarbon having at least one bromine atom.

7. A water and oil repellent composition according to claim 1, wherein the solvent component (B) is a bromine-containing solvent with at least one compound selected from the group consisting of 1-bromopropane, 2-bromopropane and 1,2-dibromopropane

8. A Water and oil repellent composition according to claim 1, which further contains (C) a cross-linking or extender component. Wherein said component (C), is selected from the group comprising one or more of the following: melamine formaldehyde derivatives, trimethylolmelamine, hexamethylolmelamine, epoxides, anhydrides and derivatives thereof. Derivatives of isocyanates, diisocyanates. Polymers containing two or more blocked isocyanate compounds or aromatic blocked isocyanates. Monomers or polymers containing isocyanate compounds, zirconium tetra-butanolate, paraffin waxes, microcrystalline or semicrystalline waxes and melamine-paraffin waxes, whereas said component (C) is 0.001% to 60% by weight of component B.

9. A Water and oil repellent composition according to claim 8, which further contains (D), which is an antibacterial and/or insect repellent component comprising one or more agents to include: Silver containing resins, silver containing zeolites, silver containing glass, silver based ion exchange compounds, triclosan and inorganic antimicrobial materials: metal based zeolites, metal salts, metal oxides, metal hydroxides, transition metal ions, zinc oxide, permethrin and pyrethroids, pyrithione containing materials, tributyl oxides derivatives, 3-iodo-2 propyl butyl carbamate, n-butyl-1,2 benzisothiazoline, 10,10′-oxybisphenoxi arsine, sodium o-phenylphenate, whereby component (D) is 0.0001% to 5% by weight of component (A).

10. A process for surface treatment of an article to be treated, which comprises treating the textile with the surface treatment compositions according to claim 1, followed by drying.

11. A process for surface treatment of an article to be treated, which comprises treating the textile with the surface treatment compositions according to claim 8, followed by drying and curing

12. A process for surface treatment of an article to be treated, which comprises treating the textile with the surface treatment compositions according to claim 9, followed by drying and curing

13. A textile which is treated with the water and oil repellent compositions according to claim 1.

14. A textile which is treated with the compositions according to claim 11.

15. A textile which is treated with insect repellent and water and oil repellent compositions according to claim 12.

16. A process for surface treatment of a textile to be treated, which comprises treating the textile with the surface treatment compositions according to claim 1, while controlling the depth of penetration, followed by drying, then applying a second surface treatment to the opposite side of the textile followed by drying and curing, creating a two-sided textile.

17. A process for surface treatment of a textile to be treated, which comprises treating the textile with the surface treatment compositions according to claims 1, 2, 3, 8 and 9, while controlling the depth of penetration, followed by drying, then applying a second non-aqueous surface treatment to the opposite side of the textile by foam application followed by drying and curing, creating a two-sided textile.

18. A process for surface treatment of a textile to be treated, which comprises treating the textile with the surface treatment compositions according to claims 1, 2, 3, 8 and 9, while controlling the depth of penetration, followed then by drying, then applying a second treatment, an aqueous surface treatment to the opposite side of the textile by foaming application, then followed by drying and curing, creating a two-sided textile.
